(19) United States
(12) Patent Application Publication
(10) Pub. No.: US 2010/0030963 A1
(43) Pub. Date: Feb. 4, 2010

(54) MANAGING STORAGE OF CACHED CONTENT

(75) Inventors: Alon MARCU, Tel-Mond (IL); Alain NOCHIMOWSKI, Tel Aviv (IL)

Correspondence Address: BEYER LAW GROUP LLP/ SANDISK, P.O. BOX 1687, CUPERTINO, CA, 95015-1687, US

(73) Assignee: SANDISK IL LTD., Kfar Saba (IL)

(21) Appl. No.: 12/185,583

(22) Filed: Aug. 4, 2008

(51) Int. Cl. G06F 12/08

(52) U.S. Cl. 711/118; 711/E12.017

(57) ABSTRACT

A method of controlling storage of content on a storage device includes communicating with a storage device configured to cache content; and determining a storage cost for caching a first set of data objects on the storage device. The determining is based, at least in part, on characteristics of the first set of data objects and on characteristics of the storage device. Also provided is a storage system that includes a storage device capable of caching media content, a storage device agent and a cache manager. The storage device agent is operative to communicate with the storage device and with the cache manager, and to provide a storage cost to the cache manager. The storage device agent determines the storage cost for caching a data object on the storage device based, at least in part, on characteristics of the data object and on characteristics of the storage device.

### FIELD OF THE INVENTION

The present invention relates generally to a storage device in a storage system. More particularly, the invention relates to using a storage device configured for storing cached content.

### BACKGROUND OF THE INVENTION

A cache memory (or “cache” for short) is typically used to duplicate original data that are stored elsewhere, where the original data are expensive to compute or to fetch, compared to the cost of reading the data locally; i.e., from the cache memory.

In the context of data, caching “cost” and “expensive” usually refer to time, storage and computing resources that are required by one device (e.g., a storage device) to fetch data from another, remote, device, usually over a data network.

Data are regarded as expensive to compute or to fetch if, for example, fetching the data takes a relatively long time. In other words, a cache memory is a temporary storage area where frequently accessed data can be stored for rapid access. Once the data is stored in the cache, future use can be made by accessing the cached copy rather than re-fetching or re-computing the original data. Cache memories use cache algorithms (also known in the fields as “replacement algorithms” or “replacement policies”) by which they manage the data storage. For example, when a cache is full, the algorithm used by the cache chooses which data object(s) to discard in order to make room for new data object(s).

Due to the limitations of the cache size (which can vary between a few megabytes to tens of megabytes for example, according to the specific configuration), the cache can store only limited number of data objects or data objects of limited size. The problem resulting from the limited cache size is exacerbated by the increased consumption by users of more and more data that are easily accessible by using mobile-networked technologies, where media content delivery over mobile (e.g., cellular) networks) becomes prevalent.

Effectiveness of a caching scheme largely depends on the used cache replacement policy. Traditional cache policies typically use a methodology called Least Recently Used (“LRU”—least recently used items first are discarded first), LRU-threshold (—items larger than a certain threshold size are never changed), or Least Frequently Used (“LFU”—items used least often first are discarded first) replacement policies for data caching. Other replacement policies consider also the size of the file to be stored or discarded, and/or latency and network costs.

Traditional cache replacement policies are problematic because they mainly relate to the usage profile and are not based on other parameters that are associated with the caching procedure, and therefore generic and not optimal.

### SUMMARY OF EXEMPLARY EMBODIMENTS

In view of the foregoing observations and the present needs, it would be advantageous to introduce a new cache replacement policy that associates a cache value with a data object in a way that the performance of media caching is optimized. In addition to or differently from the prior art, the storing and caching of a data object on a storage device is performed based on at least two factors: 1) characteristics of the storage device, and 2) the characteristics of the data object.

The storage device using the cache replacement policy disclosed herein may be any suitable storage device, for example a non-volatile storage device. By way of example, the non-volatile storage devices may be a flash memory or an EEPROM-based storage device.

Embodiments, various examples of which are discussed herein, include a method of controlling storage of content on a storage device, the method includes: communicating with a storage device configured to cache content; and determining a storage cost, for caching a first set of data objects on the storage device based, at least in part, on characteristics of the first set of data objects and on characteristics of the storage device.

The storage cost may be determined based also on characteristics of data objects to be inserted, characteristics of data object to be removed, and/or characteristics of data objects to be updated. The storage cost may be determined based also on characteristics of activity of a host affected by caching of data objects on the storage device. The characteristics of the storage device may include at least one of: an internal structure of the storage device, age of the storage device, management capabilities of the storage device, correction capabilities of the storage device, history of the storage device, content already stored on the storage device, and environmental conditions of the storage device.

The method may also include controlling caching of the first set of data objects on the storage device based, at least in part, on the storage cost. The method may also include maintaining a database of information that pertains to the characteristics on which the determination of the storage cost is based. Alternatively or additionally, the method may include dynamically updating the storage cost upon the change in the characteristics on which the determination of the storage cost is based.

In another embodiment of the foregoing approach a storage system operative to communicate with a host that includes a storage device that is configured to cache content; a storage device agent that is operative to determine a storage cost, for caching a first set of data objects on the storage device; and a cache manager that is operative to control caching of the first set of data objects, on the storage device, based, at least in part, on the storage cost. The storage device agent determines the storage cost based, at least in part, on characteristics of the first set of data objects and on characteristics of the storage device. The storage device agent is operative to communicate with the storage device and with the cache manager, and to provide the storage cost to the cache manager.

The characteristics of the storage device may include at least one of: an internal structure of the storage device, age of the storage device, management capabilities of the storage device, correction capabilities of the storage device, history of the storage device, content already stored on the storage device, and environmental conditions of the storage device.

The storage device may have a configuration that complies with a flash technology. The storage device agent may be embedded within the storage device, and may be part of a host housing the cache manager.

Additional features and advantages of the embodiments described are possible as will become apparent from the following drawings and description.

### BRIEF DESCRIPTION OF THE DRAWINGS

For a better understanding of the various embodiments, reference is made to the accompanying drawings, in which like numerals designate corresponding sections or elements throughout, and in which:

FIG. 1 is a block diagram of a storage system, according to one example embodiment;

FIG. 2 is a block diagram of a storage system, according to another embodiment;

FIG. 3 is a block diagram of the storage device of FIG. 1 where the storage device agent is embedded within the storage device;

FIG. 4 is a block diagram of the storage device of FIG. 1 where the storage device agent and the cache manger are embedded within the storage device; and

FIG. 5 is an exemplary flow chart of a method for storing a data object on a storage device, according to one embodiment.

### DETAILED DESCRIPTION OF PREFERRED EMBODIMENTS

The embodiments and various aspects thereof are further described in more details below. This description is not intended to limit the scope of claims but instead to provide examples of such embodiments. The following discussion therefore presents exemplary embodiments, which include various storage systems for communicating with a host and managing operation of a storage device. Such systems may be implemented as software, firmware, or hardware, or any combination thereof.

The storage device of the exemplary embodiments may be a dedicated, non-removable storage device that is embedded within a host; or may be a removable storage device that is configured for removal from the host.

One type of removable storage device that is suitable for use as a storage device is a memory card. Memory cards are commonly used to store digital data for various electronics devices that host them. Some memory cards are “removable”, which means that they can be removed from their hosts, thus rendering the stored digital data portable. Memory cards can have a relatively small form factor.

Digital cameras, cellular phones, media players/recorders (e.g., MP3 and MP4), hand-held or notebook computers, personal digital assistants (PDAs), network cards, network appliances, set-top boxes, and hand-held are exemplary hosts. A PDA is typically known as user-held computer systems implemented with various personal information management applications, such as an address book, a daily organizer, and electronic notepads, to name a few. The host and/or an external device may be in communication with the storage device over a wired or a wireless communication channel well known to those skilled in the art.

The storage device, storage system and/or controller of the present disclosure may comply with any type of memory device (e.g. flash memory) known in the art, and with memory device that will be devised in the future. The storage device may be a nonvolatile memory that retains its memory or stored state even when power is removed. The storage device may be an erasable programmable memory including, but not-limited to, Electrically-Erasable and Programmable Read-Only Memories (EEPROMs), EPROM, Magnetoresistive Random Access Memory (MRAM), Ferroelectric RAM (FeRAM or FRAM).

The caching replacement policy disclosed herein and the storage device using the policy do not depend on the type of memory, and may be implemented with any type of memory, whether it is a flash memory or a non-flash memory. The storage device using the caching policy disclosed herein may also comply with a 3-dimensional memory chip technology.

The storage device may conform to the secured digital (SD) memory card format, which is used for storing digital media such as audio, video, picture files, and the like files. The storage device may also conform to the multi media card (MMC) memory card format, to the compact flash (CF) memory card format, to the flash PC (e.g., ATA Flash) memory card format, to the smart-media memory card format, to the USB flash drive, or to any other standard format. One supplier of these memory cards is SanDisk Corporation, assignee of this application.

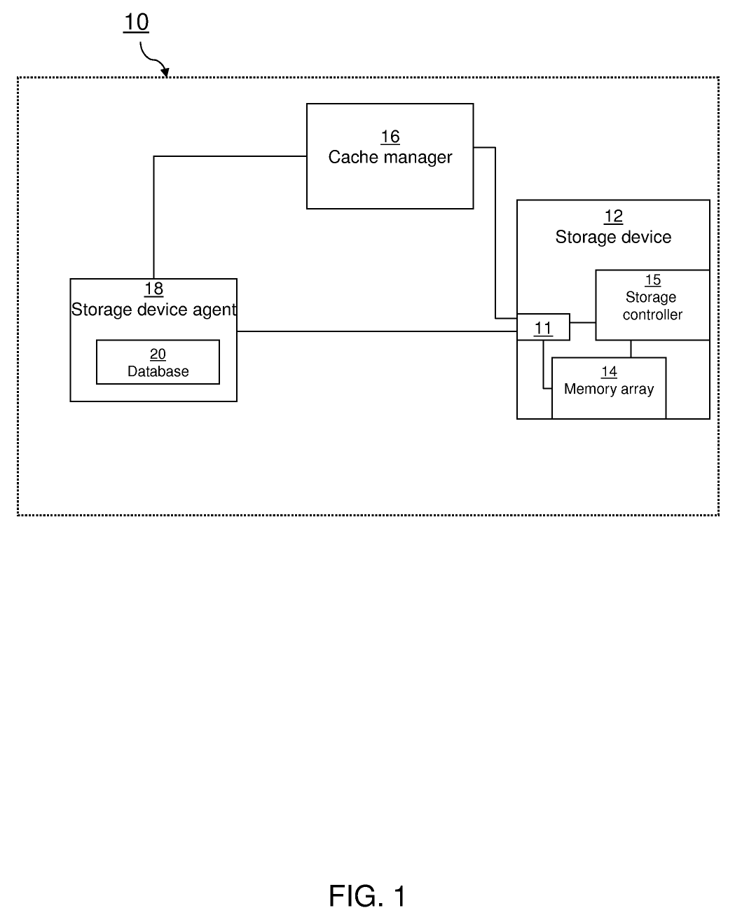

FIG. 1 is a block diagram of a storage system 10 according to one example embodiment. Storage system 10 typically includes a storage device 12, a cache manager 16, and a storage device agent 18.

Storage device 12 includes a memory 14 for storing and caching digital content, a storage controller 15 for managing memory 14, and a communication interface 11 to facilitate communication between storage controller to 15 and cache manager 16 and storage device agent 18.

Memory 14 is functionally divided into two parts, one of which functions as a cache memory (i.e., it is dedicated for cached data object). Memory array 14 can be configured as an array of volatile or non-volatile memory cells (such as FLASH).

Communication interface 11 is also connected to memory array 14. The connection between communication interface 11 and memory 14 and between communication interface 11 and storage controller 15 enable data flow into and from storage device 12. Communication interface 11 is configured to store a data object on memory 14 under the control or supervision of cache manager 16.

Storage device agent 18 determines a storage cost for potentially caching a data object on storage device 12 (i.e., on the part of memory 14 dedicated for cached data items). Storage device agent 18 may be embedded within storage device 12, or within storage controller 15, or may be external to them.

Cache manager 16 is operatively connected to storage device 12 and to storage device agent 18. Cache manager 16 controls caching and storing of data objects on storage device 12 based on, at least in part, a storage cost provided by storage device agent 18. Note that cache manager 16 controls caching and storing as such based on other criterions that are provided to it from an external device, such as network cost, user-experience cost, power consumption, etc. The cached data object may be, or it may include, continuous media content (such as streaming video content) and/or non-continuous media content (still picture, such as an HTML file for example).

In the context of this disclosure, a “storage cost” is a number indicative of the cost of caching a data object, or a set of data objects. In general, the storage cost can be positive or negative. A positive storage cost implies that the system performance will deteriorate as a result of replacing a data object (for example). A negative storage cost implies that a greater benefit is gained in retrieving a data object and freeing space on the memory (for example). The storage cost typically provides an indication of how removal, update and/or insertion of a particular data object from/to a storage device impacts the overall system wear and performance. In general, the storage device may be only one element for consideration in the overall caching equation.

In the context of this disclosure, “data object” refers to information organized as a set of binary bits according to some specification (i.e., data format) or in a specific data structure. A data object may be organized as a file (or a collection of files), sector(s), cluster(s), database record(s), one or more table entries, file header(s), other file parts, audio track(s), music record(s), map(s), video clip(s), secure content such as user account information, and the like. A “set of data objects” includes one or more data objects.

By “content” is meant herein the information bits comprising a data object and/or information pertaining to the data object. Hereinafter, “content” and “data object” are used interchangeably.

Storage device agent 18 determines a storage cost associated with a data object based on two factors, the two factors being: (1) the characteristics of the storage device on which the data object is to be stored, and (2) the characteristics of the data object. These two factors may be used in addition to, or as alternative to, other factors that are traditionally used. This may be mathematically reflected in a variety of ways. One way involves a weighted linear function giving each characteristic a corresponding weighted index. For example, some characteristics of the data object may be more important for and/or may bear more impact on the overall storage cost than other characteristics. These characteristics may then receive more weight by storage device agent 18 in the overall storage cost determination. The weighted indexes are ultimately subjective in nature and reflect a compromise between several aspects, and therefore determined with respect to the specific configuration.

Examples of characteristics of a data object include the type of the data object (e.g., fixed data, random data, etc.), and the size of the data object, among others. Storage device agent 18 may determine the storage cost based on characteristics of the data already stored on storage device 12. For example, storing fixed data (such as a text file) in comparison to random data (such as that characterizing a JPEG (Joint Photographic Experts Group) file, being a compressed file, for example), may result in a lower storage cost. Storage device agent 18 may determine the different type of data object according to the metadata associated with this data object, for example.

Characteristics of the storage device (e.g., storage device 12) include at least the internal structure of the storage device (e.g., the physical structure of the memory array). For example, caching a data object on a Single Level Cell (“SLC”) storage area has a different impact on the insertion (i.e., storage) cost compared to caching the data object on an Multi Level Cell (“MLC”) storage area. Other non-limiting examples for characteristics of the storage device are the condition (e.g., wear and age) of the storage device, management capabilities of the controller of the storage device, error correction capabilities of the storage device, history of transactions (e.g., number of read/write operations/cycles performed by the storage device, frequency of read/write operations, etc.), content already stored on the storage device, and environmental conditions of the storage device (e.g., temperature, voltage variations or voltage stability).

When calculating the storage cost, storage device agent 18 may also take into account characteristics of the storage system 10 as a whole, as opposed to characteristics of storage device 12, and processes pertaining to storage device 12. Typically, storage device agent 18 determines the storage cost based also on characteristics of data objects that are yet to be stored in the storage device, and/or on characteristics of data object that are candidates for removal and/or update.

The storage cost may be determined based also on processes, applications, drivers of the host or running on the host, the protocol set between storage device 12 and the host, and/or other host activity that is affected by the content being stored on storage device 12. For example, data transfer between the storage device and the host may influence other processes running on the host (in term of quality of service, for example). In a similar manner, processes running on the host may influence the caching of on storage device 12. This in turn may affect the storage cost.

Storage device agent 18 maintains a database of information 20 pertaining to the characteristics of storage device 12, to the characteristics of the cached content being stored on storage device 12, to the characteristics of the data objects to be inserted/removed/updated to and from storage device 12, including other characteristics and host processes on which the determination of the storage cost is based.

With every change in any one of these characteristics, storage device agent 14 dynamically updates database of information 20. Furthermore, since the characteristics of storage device 12 are influenced with every change storage device 12 is undergoing then the storage cost is dynamically updated accordingly.

In other words any insertion, replacement, removal, update, change of properties and/or any other modification of one or more data objects, including media data associated with 1) the data object, and/or 2) the storage device, may lead to a change in the storage cost of the particular data object(s). In addition, updating the storage cost of a given data object may further require updating the storage cost of any one or more other data objects. Note that the dynamic update can be applied by storage device agent 14 and/or storage device 12.

Storage device agent 18 may be embedded within storage device 12. Alternatively, storage device agent 18 is part of a host housing cache manger 16 or embedded on the host, as an integrated component within cache manager 16. If storage device agent 18 is not an internal component of storage device 12, then storage device agent 18 is operable to communicate with storage device 12 for obtaining its characteristics.

The storage control performed by cache manager 16 includes programming a data object on storage device 12. If the storage portion is not full, cache manager 16 programs a given data object on storage device 12. However if the storage portion is full, cache manager 16 needs to determine which data object to remove. Cache manager 16 determines this based on a set of metrics that are provided thereto.

Typically, a data object with the lowest storage cost value (as indicated by the corresponding set of metrics) has the smallest impact on degrading the overall system performance, so it is selected to be replaced. Note that an existing data object for replacement may be selected by storage device agent 14 and/or cache manager 16, according to the specific configuration.

Such storage control may vary from one cache manager to another, as well as from one system configuration to another.

For example, a cache manager complying with a first configuration may determine that the impact for replacement/retrieval of a certain data object and freeing memory space on storage device 12 in the overall caching equation is beneficial, in terms of system performance; whereas a cache manager complying with a second configuration may determine that such replacement/retrieval is not efficient to the overall system performance.

Upon determining the removal cost and insertion cost, cache manager 16 may now cache the data object on cache portion 15 of storage device 12, thus typically replacing a data object having the smallest impact on degrading the overall system performance.

With storage device 12 being a component of storage system 10, cache manager 16 may control caching of the data object based also on a caching cost that is not the storage cost. For example, the caching cost may be an indication of a network cost (i.e., the cost for transferring each byte of a data object in and out of a networked device and within the storage system), a user-experience cost (i.e., the amount of time it takes to load the entire data object onto the storage device due the placement of the data object in an html page, etc.), CPU consumption, and/or power consumption. Furthermore, cache manager 16 may further control caching of a data in combination to or in addition to any replacement policy known today or still to be introduced.

As described herein above, there are multiple objectives for media caching. All these objectives are competing with each other for caching usage. If one using the exemplary embodiment wishes to pay more (in terms of cache cost) for a specific characteristic of the storage device, storage device agent 14 can be configured to favor such aspect.

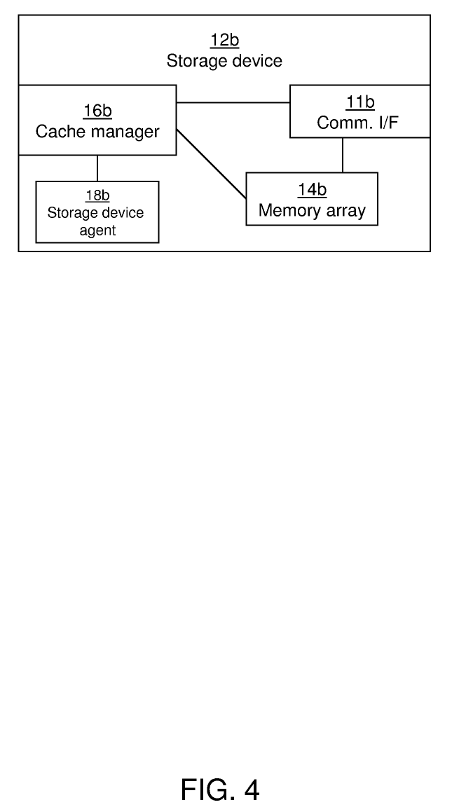

According to one implementation, cache manager 16 resides in storage device 12. One exemplary embodiment for implementing a cache manager in a storage device as such is represented in FIG. 4. According to another implementation, cache manager 16 may be a remote device that is external to storage device 12 and connectable to storage device 12 in a wired and/or wireless communication link. Accordingly, cache manager 16 may reside in a host along with storage device 12 and physically separated from storage device 12.

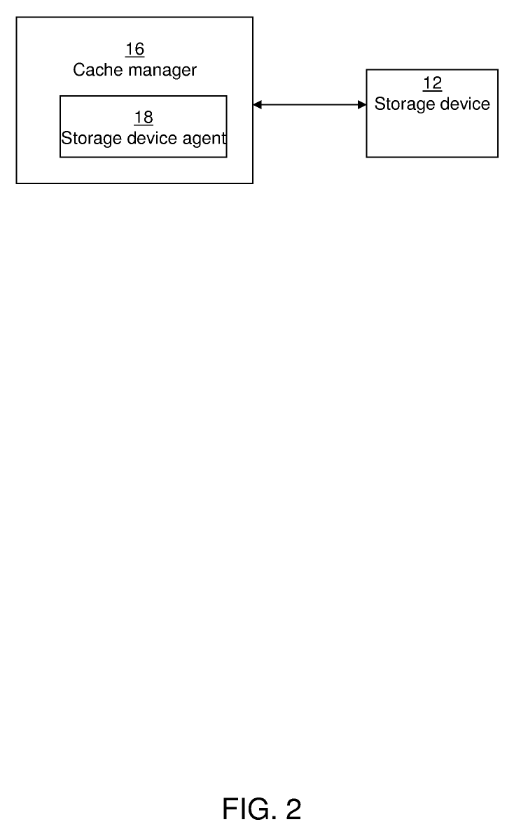

FIG. 2 is a block diagram of the storage system of FIG. 1 where storage device agent 18 is embedded within cache manager 16. In this exemplary embodiment, storage device agent 18 is a component of cache manager 16, storage device agent 18 being in communication with storage device 12 via cache manager 18.

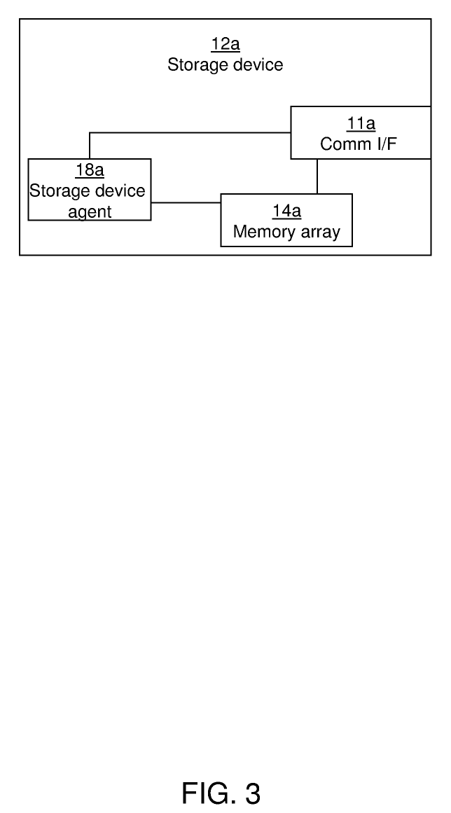

FIG. 3 is a block diagram of a storage device 12a where storage device agent 18a is embedded within storage device 12a. Storage device 12a includes a memory array 14a, a communication interface 11a, and a storage device agent 18a, which function in a similar way as memory array 14, communication interface 11, and storage device agent 18, respectively, of FIG. 1, for example.

FIG. 4 is a block diagram of a storage device 12b, where storage device agent 18b and cache manager 16b are embedded within the storage device and in communication with each other using the resources of storage device 12b. Storage device 12b includes a memory array 14b, communication interface 11b and a storage device agent 18b, which function in a similar way as memory array 14, communication interface 11, and storage device agent 18, respectively, of FIG. 1, for example.

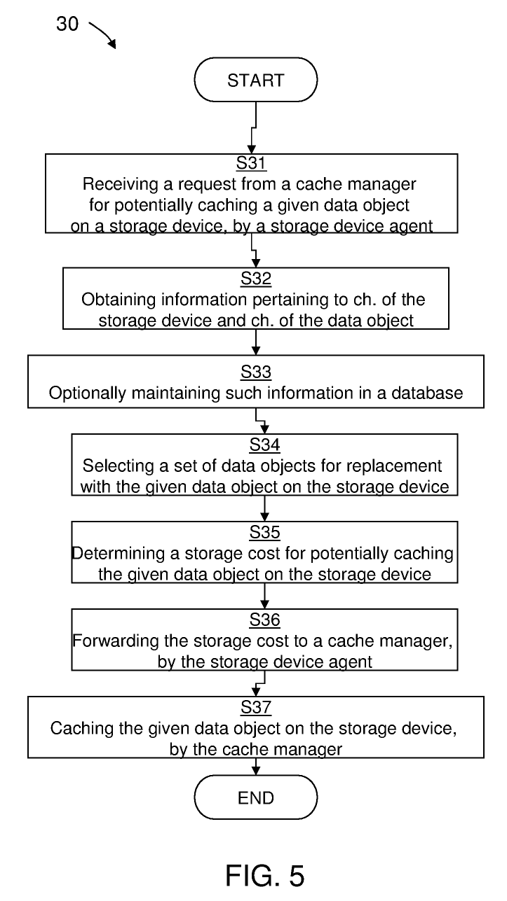

FIG. 5 is a flow chart of a method 30 for storing a new data object on a caching portion of a storage device, according to one embodiment. The method shown in FIG. 5 is executed by a storage device agent, such as storage device agent 18 of FIG. 1, to associate a cost value with each new data object that is a candidate for caching in memory 14 of storage device 12. As stated above, the cost value is calculated for a new data object based on at least two factors: characteristics of the storage device and characteristics of the new data object.

At step S31, storage device agent 18 receives a request from cache manager 16 to cache a new data object on storage device 12.

At step S32 storage device agent 18 obtains information pertaining to characteristics of storage device 12 and to characteristics of the new data object. The characteristics of storage device 12, which are used to calculate the storage cost, may dynamically change over time and may include various structural characteristics, as well as other physical characteristics of storage device 12, as described above (e.g., age of the storage device, management capabilities of the storage device, etc.). These characteristics used to calculate the storage cost of the new data object and may be optionally stored, at step S33, in a database that is dynamically updated by storage device agent 18.

At step S34 storage device agent 18 evaluates already cached data items and selects one or more cached data objects in order for them to be replaced by the new data object, or only updated with the new data object. Note that either storage device agent 18 and/or cache manager 16 may select the data objects that are designated for replacement/update.

Selecting a data object for replacement at step S36 may be applied based on the size of the designated data object to be inserted, in terms of how many cached data object(s) should, or can be removed to make room for the designated data object for example. Storage device agent 18 may determine a replacement cost (or may have access to such replacement cost) for replacing/retrieving a data object from storage device 12 in any of a variety of means known in the art. According to one example, storage device agent 18 pre-determines the replacement cost for a particular data object at the time this data object is cached in storage device 12. Then when device agent 18 is required to select a data object(s) for replacement, storage device agent 18 can determine the data object (or a group of data objects) of the minimal required size and of the minimal replacement cost.

At step S35 storage device agent 18 calculates a storage cost for caching the new data object on the storage device. As stated above, such determination is based on the characteristics of storage device 12 and on the characteristics of the new data object that is yet to be cached, and, optionally, on characteristics of the cached data objects that are candidates for removal from memory 14. The storage cost calculated for the new data object may be determined based also on the effect that caching of data objects on memory 14 has on the activity of the host hosting storage device 12. Information pertaining to the host activity may be communicated from the host to storage device agent 18 over a communication path.

Then at step S36 storage device agent 18 forwards the storage cost to cache manager 16 in order to allow cache manager 16 to manage/control the caching of the data object on memory 14 based on (at least in part) the storage cost (S37). Again, the storage cost provided thereto may be only one element in the overall cache equation considered by the cache manager, and may add up to other caching costs (that are not the storage cost) that are provided for the cache control operation.

The storage device of the exemplary embodiments may be a specialized device pre-configured with this functionality or a device that has been configured to include at least some of the functionalities mentioned herein above.

As will be appreciated by those familiar in the art, current storage devices employ a wide variety of different architectures and it is expected that new architectures will continue to be developed. In general, the exemplary embodiments may be employed in conjunction with a wide variety of different types of memory, so long as the storage device being used has suitable processing power.

The embodiments, various examples of which are described herein, may be realized in hardware, software, firmware or any combination of hardware and software. A typical combination of hardware and software could be a general purpose computer system with a computer program that, when being loaded and executed, controls the computer system such that it carries out the methods described herein. The concept described above can also be embedded in a computer program product, which comprises all the features enabling the implementation of the embodiments described herein, and which, when loaded in a computer system is able to carry out these embodiments. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Having described the various embodiments of a storage device and a method, it is to be understood that the description is not meant as a limitation, since further modifications will now suggest themselves to those skilled in the art, and it is intended to cover such modifications as fall within the scope of the appended claims.

1. A method of controlling storage of content on a storage device, the method comprising:
communicating with a storage device configured to cache content; and
determining a storage cost, for caching a first set of data objects on the storage device based, at least in part, on characteristics of the first set of data objects and on characteristics of the storage device.

2. The method of claim 1, further comprising:
controlling caching of the first set of data objects on the storage device based, at least in part, on the storage cost.

3. The method of claim 1, wherein the storage cost is determined based also on characteristics of data objects to be inserted.

4. The method of claim 1, wherein the storage cost is determined based also on characteristics of data object to be removed.

5. The method of claim 1, wherein the storage cost is determined based also on characteristics of data objects to be updated.

6. The method of claim 1, wherein the characteristics of the storage device include at least one of: an internal structure of the storage device, age of the storage device, management capabilities of the storage device, correction capabilities of the storage device, history of the storage device, content already stored on the storage device, and environmental conditions of the storage device.

7. The method of claim 1, further comprising:
maintaining a database of information pertaining to the characteristics on which the determination of the storage cost is based.

8. The method of claim 1, further comprising:
dynamically updating the storage cost upon the change in the characteristics on which the determination of the storage cost is based.

9. The method of claim 1, wherein the storage cost is determined based also on characteristics of activity of a host affected by caching of data objects on the storage device.

10. A storage system operative to communicate with a host, the storage system comprising:
a storage device configured to cache content;
a storage device agent operative to determine a storage cost, for caching a first set of data objects on the storage device based, at least in part, on characteristics of the first set of data objects and on characteristics of the storage device; and
a cache manager that is operative to control caching of the first set of data objects, on the storage device, based, at least in part, on the storage cost, wherein the storage device agent is operative to communicate with the storage device and with the cache manager, and to provide the storage cost to the cache manager.

11. The storage system of claim 10, wherein the characteristics of the storage device include at least one of: an internal structure of the storage device, age of the storage device, management capabilities of the storage device, correction capabilities of the storage device, history of the storage device, content already stored on the storage device, and environmental conditions of the storage device.

12. The storage system of claim 10, wherein the storage device has a configuration that complies with a flash technology.

13. The storage system of claim 10, wherein the storage device agent is embedded within the storage device.

14. The storage system of claim 10, wherein the storage device agent is part of a host housing the cache manager.
